(19) United States
(12) Patent Application Publication
(10) Pub. No.: US 2026/0208497 A1
(43) Pub. Date: Jul. 23, 2026

(54) THERMAL PRINT HEAD, THERMAL PRINT SYSTEM, AND METHOD OF MANUFACTURING THERMAL PRINT HEAD

(71) Applicant: ROHM CO., LTD., Kyoto-shi (JP)

(72) Inventor: Goro NAKATANI, Kyoto-shi (JP)

(21) Appl. No.: 19/568,260

(22) Filed: Mar. 16, 2026

Related U.S. Application Data
(63) Continuation of application No. PCT/JP2024/032319, filed on Sep. 10, 2024.

(30) Foreign Application Priority Data
Sep. 22, 2023 (JP) 2023-158434

(51) Int. Cl. B41J 2/335; B41J 2/345; B41J 11/04; B41J 11/14

(52) U.S. Cl. CPC B41J 2/3353; B41J 2/3354; B41J 2/3355; B41J 2/3359; B41J 2/345; B41J 11/04; B41J 11/14

(57) ABSTRACT

A thermal print head includes a substrate, a first insulating film, and a second insulating film. The substrate has a first main surface and a second main surface opposite to the first main surface. A protruding portion protruding toward a side opposite to the second main surface is formed at the first main surface. A recessed portion is formed in a surface of the protruding portion. The first insulating film is disposed on the first main surface to cover the protruding portion. The second insulating film is disposed on the surface with the first insulating film interposed therebetween. A through hole is formed in a portion of the first insulating film that faces a bottom surface of the recessed portion with a space interposed therebetween.

### TECHNICAL FIELD

The present disclosure relates to a thermal print head, a thermal print system, and a method of manufacturing the thermal print head.

### BACKGROUND ART

For example, Japanese Patent Laying-Open No. 2019-14233 (PTL 1) discloses a thermal print head. The thermal print head disclosed in PTL 1 has a substrate, an insulating film, a resistor layer, a wiring layer, and a protective film.

The substrate has a first main surface and a second main surface. The second main surface is opposite to the first main surface. The first main surface is provided with a protruding portion. The protruding portion protrudes toward a side opposite to the second main surface. The protruding portion extends in a first direction in a plan view. The insulating film is disposed on the first main surface to cover the protruding portion. The wiring layer is disposed on the insulating film with the resistor layer interposed therebetween.

The wiring layer has a plurality of wiring portions. The plurality of wiring portions are arranged at intervals in the first direction. Each of the plurality of wiring portions extends in a second direction orthogonal to the first direction so as to overlap with the protruding portion. The resistor layer has a heater portion. Each of the plurality of wiring portions is partially removed on the heater portion. The protective film is disposed on the insulating film to cover the wiring layer and the resistor layer.

Paper for printing is interposed between a platen roller and the protective film located above the heater portion. During printing, a current is passed through each of the plurality of wiring portions. As the current flows through the heater portion, the heater portion generates resistance heat. This heat is transferred to the paper, so that printing is performed on the paper.

### CITATION LIST

### Patent Literature

PTL 1: Japanese Patent Laying-Open No. 2019-14233

### BRIEF DESCRIPTION OF DRAWINGS

FIG. 1 is a plan view of a thermal print head 100.

FIG. 2 is a cross-sectional view taken along a line II-II in FIG. 1.

FIG. 3 is a cross-sectional view taken along a line III-III in FIG. 1.

FIG. 4 is a diagram of manufacturing steps of thermal print head 100.

FIG. 5 is a cross-sectional view for illustrating a hard mask forming step S21.

FIG. 6 is a cross-sectional view for illustrating a first etching step S22.

FIG. 7 is a cross-sectional view for illustrating a second etching step S23.

FIG. 8 is a cross-sectional view for illustrating a first insulating film forming step S3.

FIG. 9 is a cross-sectional view for illustrating a through hole forming step S4.

FIG. 10 is a cross-sectional view for illustrating a recessed portion forming step S5.

FIG. 11 is a cross-sectional view for illustrating a second insulating film forming step S6.

FIG. 12 is a cross-sectional view for illustrating a film forming step S7.

FIG. 13 is a cross-sectional view for illustrating a first etching step S8.

FIG. 14 is a cross-sectional view for illustrating a second etching step S9.

FIG. 15 is a cross-sectional view for illustrating a third etching step S10.

FIG. 16 is a cross-sectional view of a thermal print head 100 according to a modification.

FIG. 17 is a cross-sectional view of a thermal print head 200.

FIG. 18 is a diagram of manufacturing steps of thermal print head 200.

FIG. 19 is a cross-sectional view of thermal print head 200 according to a modification.

FIG. 20 is a schematic diagram of a thermal print system 300.

### DETAILED DESCRIPTION

Embodiments of the present disclosure will be described in detail with reference to the drawings. In the accompanying drawings, the same or corresponding portions are denoted by the same reference characters, and the description thereof will not be repeated.

### First Embodiment

A thermal print head according to the first embodiment will be described. The thermal print head according to the first embodiment is referred to as a thermal print head 100.

### Configuration of Thermal Print Head 100

The configuration of thermal print head 100 will be described below.

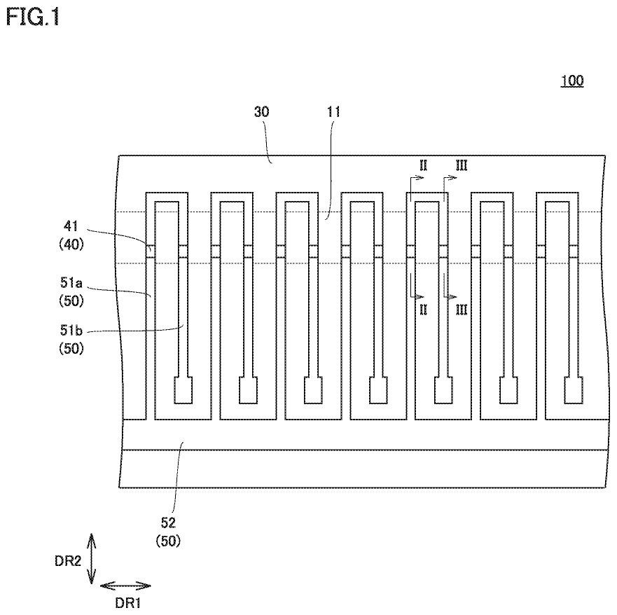

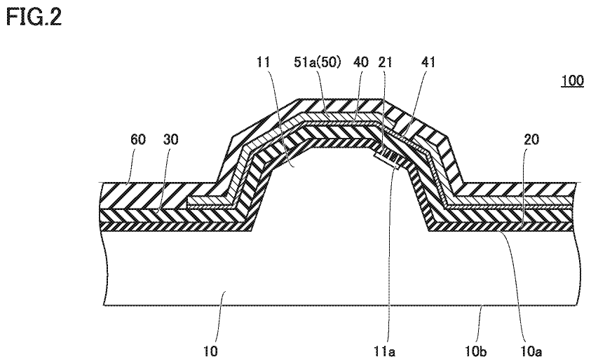

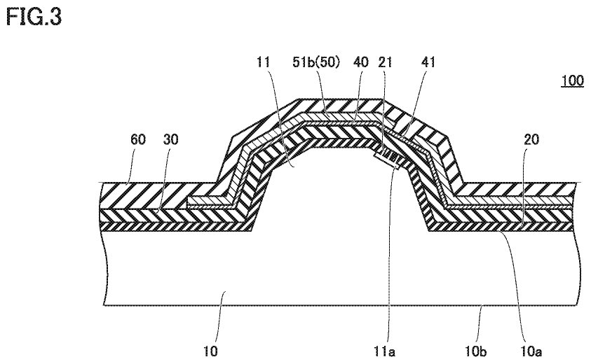

FIG. 1 is a plan view of thermal print head 100. FIG. 1 does not show a protective film 60. FIG. 1 shows a protruding portion 11 indicated by dotted lines. FIG. 2 is a cross-sectional view taken along a line II-II in FIG. 1. FIG. 3 is a cross-sectional view taken along a line III-III in FIG. 1. As shown in FIGS. 1 to 3, thermal print head 100 has a substrate 10, insulating films 20 and 30, a resistor layer 40, a wiring layer 50, and protective film 60.

Substrate 10 has main surfaces 10a and 10b. Main surfaces 10a and 10b are respective end surfaces of substrate 10 in its thickness direction. Main surface 10b is opposite to main surface 10a. Protruding portion 11 is formed at main surface 10a. Protruding portion 11 extends in a first direction DR1 in a plan view. Note that the plan view refers to a view of thermal print head 100 as seen in the direction normal to main surface 10a. Protruding portion 11 protrudes toward a side opposite to main surface 10b.

In a cross-sectional view orthogonal to first direction DR1, protruding portion 11 has a top surface, two first side surfaces, and two second side surfaces. The two first side surfaces form end surfaces of protruding portion 11 in a second direction DR2. Second direction DR2 is orthogonal to first direction DR1 in a plan view. A distance between the two first side surfaces increases with distance from the top surface. The second side surface is contiguous at its upper end to the top surface and contiguous at its lower end to the first side surface. Protruding portion 11 has a surface provided with a recessed portion 11a. More specifically, recessed portion 11a is formed in the second side surface of protruding portion 11. A constituent material of substrate 10 is, for example, monocrystalline silicon.

Insulating film 20 is disposed on main surface 10a to cover protruding portion 11. A through hole 21 is provided in a portion of insulating film 20 that faces a bottom surface of recessed portion 11a with a space interposed therebetween. Through hole 21 passes through insulating film 20 in its thickness direction. From a different point of view, through hole 21 communicates with recessed portion 11a. An opening diameter of through hole 21 is, for example, equal to or less than a thickness of insulating film 30. The opening diameter of through hole 21 is preferably equal to or less than 2 μm. A constituent material of insulating film 20 is, for example, silicon oxide.

Insulating film 30 is disposed on insulating film 20. In other words, insulating film 30 is disposed on the surface of protruding portion 11 with insulating film 20 interposed therebetween. Through hole 21 is closed by insulating film 30. A constituent material of insulating film 30 is, for example, silicon oxide. Insulating film 30 is preferably a plasma chemical vapor deposition (CVD) film. The plasma CVD film is a film formed by plasma CVD.

Wiring layer 50 is disposed on insulating film 30 with resistor layer 40 interposed therebetween. A constituent material of resistor layer 40 is, for example, tantalum nitride. Although not shown, an intermediate layer may be interposed between resistor layer 40 and wiring layer 50. A constituent material of the intermediate layer is, for example, titanium.

Wiring layer 50 has a plurality of wiring portions 51 and a connection portion 52. The plurality of wiring portions 51 are arranged at intervals in first direction DR1. Each wiring portion 51 extends in second direction DR2 so as to overlap with protruding portion 11 in a plan view.

The plurality of wiring portions 51 include a plurality of wiring portions 51a and a plurality of wiring portions 51b. Wiring portions 51a and wiring portions 51b are alternately arranged in first direction DR1. One end of each wiring portion 51a (an upper end in FIG. 1) and one end of each wiring portion 51b (an upper end in FIG. 1) are connected to each other. The other end of each wiring portion 51a is connected to connection portion 52. Connection portion 52 extends in first direction DR1. A constituent material of wiring layer 50 is, for example, copper or a copper alloy.

Resistor layer 40 has a heater portion 41. Heater portion 41 is located above a portion of insulating film 20 where through hole 21 is provided. In other words, heater portion 41 is positioned to overlap with recessed portion 11a. Wiring portion 51 (and the intermediate layer) is partially removed on heater portion 41. From a different point of view, heater portion 41 is exposed from wiring portion 51.

Protective film 60 is disposed on insulating film 30 to cover resistor layer 40 and wiring layer 50. Although not shown, protective film 60 is provided with a plurality of first openings and a second opening. The other end of each of the plurality of wiring portions 51b is exposed from a corresponding one of the plurality of first openings. A part of connection portion 52 is exposed from the second opening. Bonding pads are formed on the other ends of wiring portions 51b exposed from the first openings and on the part of connection portion 52 exposed from the second opening. Each bonding pad has, for example, a nickel layer, a palladium layer disposed on the nickel layer, and a gold layer disposed on the palladium layer. A constituent material of protective film 60 is, for example, silicon nitride.

### Method of Manufacturing Thermal Print Head 100

A method of manufacturing thermal print head 100 will be described below.

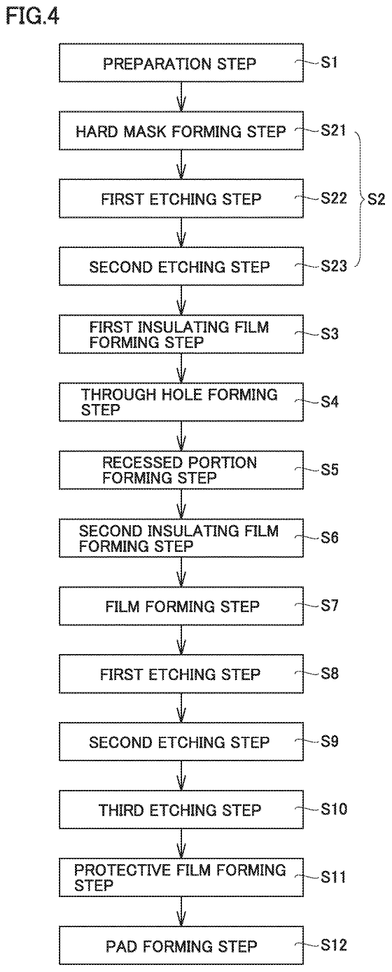

FIG. 4 is a diagram of manufacturing steps of thermal print head 100. As shown in FIG. 4, the method of manufacturing thermal print head 100 includes a preparation step S1, a protruding portion forming step S2, a first insulating film forming step S3, a through hole forming step S4, a recessed portion forming step S5, a second insulating film forming step S6, a film forming step S7, a first etching step S8, a second etching step S9, a third etching step S10, a protective film forming step S11, and a pad forming step S12.

In preparation step S1, substrate 10 is prepared. After preparation step S1, protruding portion forming step S2 is performed. Protruding portion forming step S2 includes a hard mask forming step S21, a first etching step S22, and a second etching step S23. First etching step S22 is performed after hard mask forming step S21, and second etching step S23 is performed after first etching step S22.

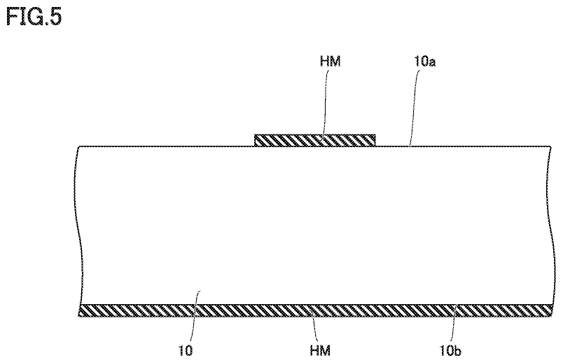

FIG. 5 is a cross-sectional view for illustrating hard mask forming step S21. As shown in FIG. 5, in hard mask forming step S21, a hard mask HM is formed on a portion of main surface 10a on which protruding portion 11 is to be formed. Hard mask HM is formed also on main surface 10b.

In hard mask forming step S21, firstly, a constituent material of hard mask HM is deposited as a film on the surface of substrate 10, for example, by a low-pressure CVD method. Secondly, a resist pattern is formed on the film of the constituent material of hard mask HM deposited on main surface 10a. Thirdly, using the resist pattern as a mask, anisotropic etching such as reactive ion etching (RIE) is performed on the film of the constituent material of hard mask HM deposited on main surface 10a, so that the film of the constituent material of hard mask HM deposited on main surface 10a is patterned. After hard mask HM is formed, the resist pattern is removed.

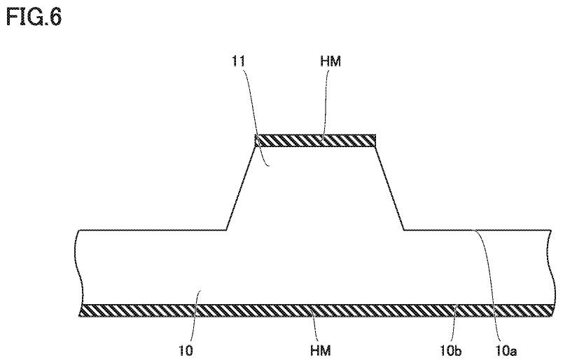

FIG. 6 is a cross-sectional view for illustrating first etching step S22. As shown in FIG. 6, in first etching step S22, wet etching is performed with hard mask HM used as a mask, so that protruding portion 11 is formed. At a stage subsequent to first etching step S22, protruding portion 11 has a top surface and a first side surface, but does not have a second side surface. For wet etching, a potassium hydroxide aqueous solution is used as an etchant. After the wet etching is performed, hard mask HM is removed, for example, using a hydrofluoric acid aqueous solution.

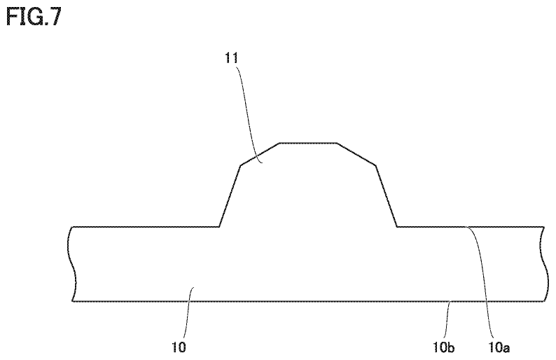

FIG. 7 is a cross-sectional view for illustrating second etching step S23. As shown in FIG. 7, in second etching step S23, wet etching is further performed, so that the second side surface is formed at a corner formed by the top surface and the side surface of protruding portion 11. For wet etching, a tetramethylammonium hydroxide (TMAH) aqueous solution is used as an etchant.

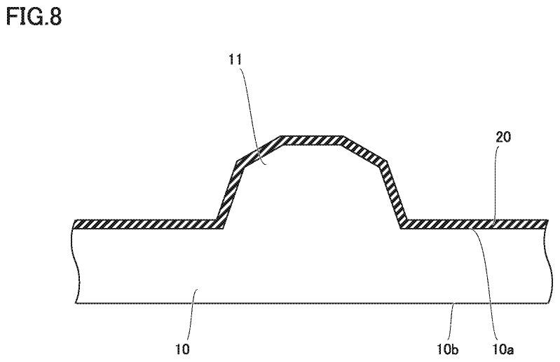

After protruding portion forming step S2, first insulating film forming step S3 is performed. FIG. 8 is a cross-sectional view for illustrating first insulating film forming step S3. As shown in FIG. 8, in first insulating film forming step S3, insulating film 20 is formed. Insulating film 20 is formed, for example, by subjecting substrate 10 to thermal oxidation.

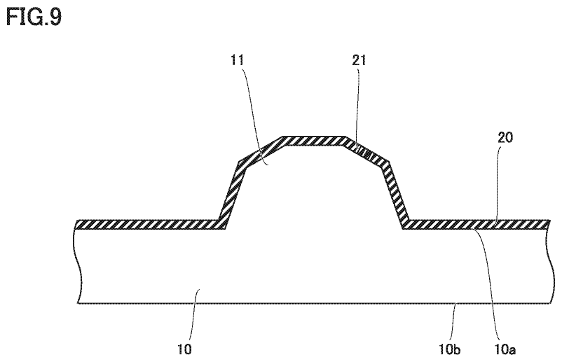

After first insulating film forming step S3, through hole forming step S4 is performed. FIG. 9 is a cross-sectional view for illustrating through hole forming step S4. As shown in FIG. 9, in through hole forming step S4, through hole 21 is formed in insulating film 20. In through hole forming step S4, firstly, a resist pattern is formed on insulating film 20. Secondly, anisotropic dry etching with the resist pattern used as a mask is performed on insulating film 20, so that through hole 21 is formed. The resist pattern is removed after the dry etching.

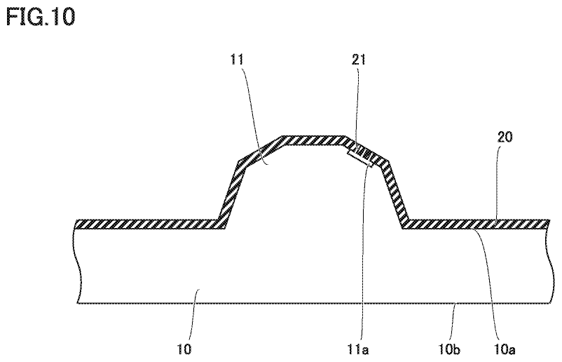

After through hole forming step S4, recessed portion forming step S5 is performed. FIG. 10 is a cross-sectional view for illustrating recessed portion forming step S5. As shown in FIG. 10, in recessed portion forming step S5, recessed portion 11a is formed in the surface of protruding portion 11. In recessed portion forming step S5, firstly, anisotropic dry etching is performed with insulating film 20 used as a mask, so that holes are formed in the surface of protruding portion 11 that is exposed from through hole 21. The holes each have a depth adjusted such that the constituent material of substrate 10 does not remain between the bottom surface of recessed portion 11a and insulating film 20 after isotropic dry etching described later is performed. Secondly, by performing isotropic dry etching with insulating film 20 used as a mask, the holes formed by the above-mentioned anisotropic dry etching extend also in the direction (the lateral direction) along the surface of protruding portion 11 to be connected to each other to thereby form recessed portion 11a.

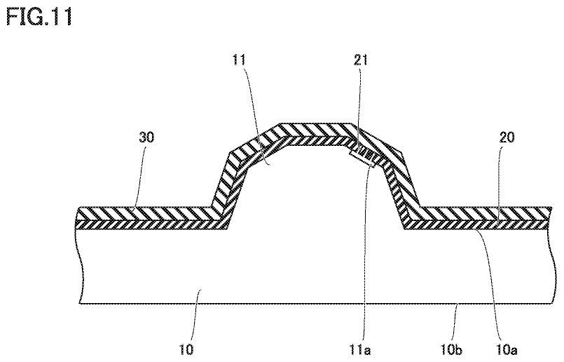

After recessed portion forming step S5, second insulating film forming step S6 is performed. FIG. 11 is a cross-sectional view for illustrating second insulating film forming step S6. As shown in FIG. 11, in second insulating film forming step S6, insulating film 30 is formed, for example, by the plasma CVD method.

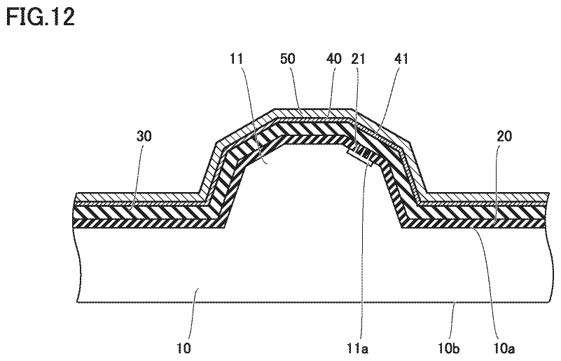

After second insulating film forming step S6, film forming step S7 is performed. FIG. 12 is a cross-sectional view for illustrating film forming step S7. As shown in FIG. 12, for example, by performing sputtering in film forming step S7, the constituent material of resistor layer 40, the constituent material of the intermediate layer, and the constituent material of wiring layer 50 are sequentially deposited as films.

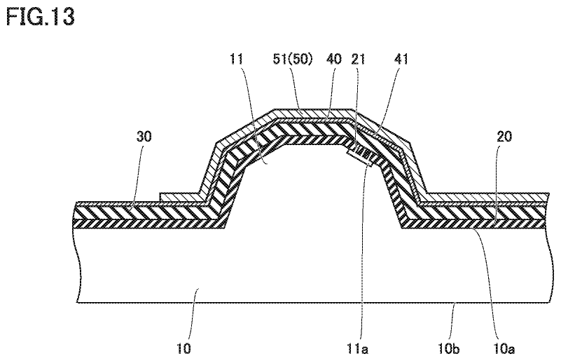

After film forming step S7, first etching step S8 is performed. FIG. 13 is a cross-sectional view for illustrating first etching step S8. As shown in FIG. 13, in first etching step S8, the constituent material of wiring layer 50 is patterned, so that wiring portion 51 and connection portion 52 (not shown in FIG. 13) are formed.

In first etching step S8, firstly, a resist pattern is formed on the deposited film of the constituent material of wiring layer 50. Secondly, for example, by performing wet etching with the resist pattern used as a mask, the deposited film of the constituent material of wiring layer 50 is patterned. After the deposited film of the constituent material of wiring layer 50 is patterned, the resist pattern is removed. In first etching step S8, after the deposited film of the constituent material of wiring layer 50 is patterned, wet etching is performed with wiring layer 50 used as a mask, so that a portion of the intermediate layer that is not located below wiring layer 50 is removed.

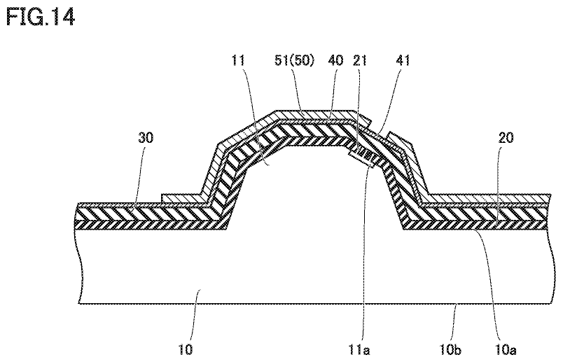

After first etching step S8, second etching step S9 is performed. FIG. 14 is a cross-sectional view for illustrating second etching step S9. As shown in FIG. 14, in second etching step S9, wiring portion 51 on heater portion 41 is partially removed. In second etching step S9, firstly, a resist pattern is formed on wiring layer 50. The resist pattern has an opening above heater portion 41. Secondly, by performing wet etching with the resist pattern used as a mask, wiring portion 51 located on heater portion 41 is partially removed. At this time, the intermediate layer on heater portion 41 is also partially removed. The resist pattern is removed after the wet etching.

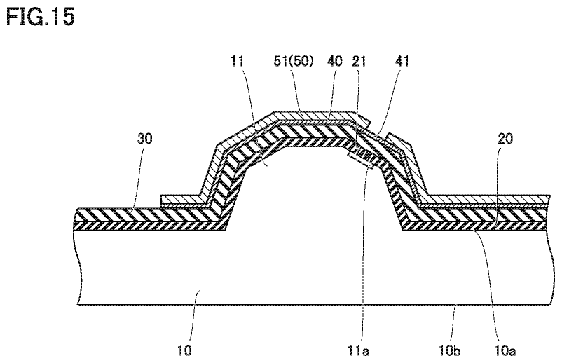

After second etching step S9, third etching step S10 is performed. FIG. 15 is a cross-sectional view for illustrating third etching step S10. As shown in FIG. 15, in third etching step S10, a portion of resistor layer 40 excluding: a part of resistor layer 40 that forms heater portion 41; and a part of resistor layer 40 that is located below wiring portion 51 is removed. In third etching step S10, firstly, a resist pattern is formed. Secondly, resistor layer 40 is removed by anisotropic dry etching such as RIE with the resist pattern used as a mask.

After third etching step S10, protective film forming step S11 is performed. In protective film forming step S11, protective film 60 is formed. In protective film forming step S11, firstly, the constituent material of protective film 60 is deposited as a film, for example, by the CVD method so as to cover resistor layer 40 and wiring layer 50. Secondly, a resist pattern is formed on the deposited film of the constituent material of protective film 60. Thirdly, a first opening and a second opening are provided by performing anisotropic dry etching such as RIE with the resist pattern used as a mask.

After protective film forming step S11, pad forming step S12 is performed. In pad forming step S12, bonding pads are formed, for example, by an electroless plating method on the other end of wiring portion 51b that is exposed from the first opening of protective film 60 and on a part of connection portion 52 that is exposed from the second opening of protective film 60. In this way, thermal print head 100 having the structure shown in FIGS. 1 to 3 is formed.

### Modifications

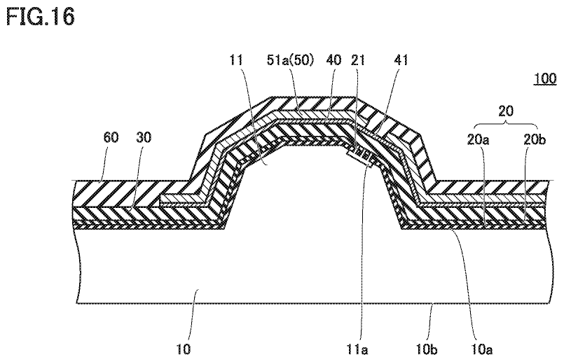

FIG. 16 is a cross-sectional view of a thermal print head 100 according to a modification. As shown in FIG. 16, insulating film 20 may be composed of a plurality of layers. For example, insulating film 20 may be composed of a first layer 20a and a second layer 20b. First layer 20a is disposed on main surface 10a to cover protruding portion 11. Second layer 20b is disposed on first layer 20a. Constituent materials of first layer 20a and second layer 20b are, for example, silicon oxide and silicon nitride, respectively. If insulating film 20 is composed of first layer 20a and second layer 20b, in first insulating film forming step S3, first layer 20a is formed, for example, by thermal oxidation, and thereafter, second layer 20b is formed, for example, by the CVD method.

### Effects of Thermal Print Head 100

Effects of thermal print head 100 will be described below.

In thermal print head 100, as a result of formation of recessed portion 11a in the surface of protruding portion 11, insulating film 20 located below heater portion 41 is spaced apart from the surface of protruding portion 11, so that the heat generated in heater portion 41 is hardly transferred to protruding portion 11. Thus, according to thermal print head 100, the temperature of heater portion 41 can be raised with low power consumption, and thermal print head 100 can be driven, for example, by a battery.

When printing is performed on paper using thermal print head 100, a platen roller comes into contact with heater portion 41 from above with the paper interposed therebetween. By increasing the pressing force from the platen roller, the amount of deflection of insulating film 20 located below heater portion 41 increases, so that insulating film 20 located below heater portion 41 comes into contact with the bottom surface of recessed portion 11a. When insulating film 20 located below heater portion 41 contacts the bottom surface of recessed portion 11a, the heat generated in heater portion 41 is transferred to protruding portion 11 through the portion of contact therebetween, so that heater portion 41 is readily cooled. This consequently allows for high-speed printing. In this way, according to thermal print head 100, adjusting the pressing force of the platen roller makes it possible to perform an operation while switching the operation state between an operation state that allows for an operation with low power consumption and an operation state that allows for high-speed printing.

In thermal print head 100, recessed portion forming step S5 is performed by isotropic dry etching, so that recessed portion 11a having a shallow depth can be formed. Consequently, when the pressing force of the platen roller is increased, insulating film 20 located below heater portion 41 and the bottom surface of recessed portion 11a are easily brought into contact with each other. If insulating film 30 is a plasma CVD film, insulating film 30 is more likely to grow conformally, and therefore, insulating films 30 growing around through hole 21 easily come into integral contact with each other, so that through hole 21 is easily closed by such insulating film 30. If the opening diameter of through hole 21 is equal to or less than the thickness of insulating film 30, through hole 21 can be closed more reliably by insulating film 30.

### Second Embodiment

A thermal print head according to the second embodiment will be described. The thermal print head according to the second embodiment is referred to as a thermal print head 200. Herein, differences from thermal print head 100 will be mainly described and the same description will not be repeated.

### Configuration of Thermal Print Head 200

The configuration of thermal print head 200 will be described below.

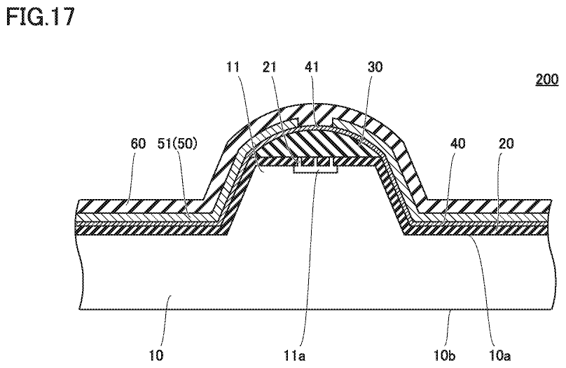

FIG. 17 is a cross-sectional view of thermal print head 200. As shown in FIG. 17, thermal print head 200 has substrate 10, insulating films 20 and 30, resistor layer 40, wiring layer 50, and protective film 60. In this respect, the configuration of thermal print head 200 is the same as that of thermal print head 100.

In thermal print head 200, protruding portion 11 does not have a second side surface in a cross-sectional view orthogonal to first direction DR1. In other words, in thermal print head 200, the first side surface is contiguous at its upper end to the top surface. In thermal print head 200, recessed portion 11a is formed in the top surface of protruding portion 11. In thermal print head 200, a constituent material of insulating film 30 is glass, and insulating film 30 is disposed only on the top surface of protruding portion 11 with insulating film 20 interposed therebetween.

In thermal print head 200, in a portion where wiring layer 50 overlaps with the top surface of protruding portion 11 in a plan view, wiring layer 50 is disposed on insulating film 30 with resistor layer 40 interposed therebetween, but in the portion other than the above, wiring layer 50 is disposed on insulating film 20 with resistor layer 40 interposed therebetween. In thermal print head 200, in a portion where protective film 60 overlaps with protruding portion 11 in a plan view, protective film 60 is disposed on insulating film 30 so as to cover resistor layer 40 and wiring layer 50, but in the portion other than the above, protective film 60 is disposed on insulating film 20 so as to cover resistor layer 40 and wiring layer 50. In these respects, the configuration of thermal print head 200 is different from that of thermal print head 100.

### Method of Manufacturing Thermal Print Head 200

A method of manufacturing thermal print head 200 will be described below.

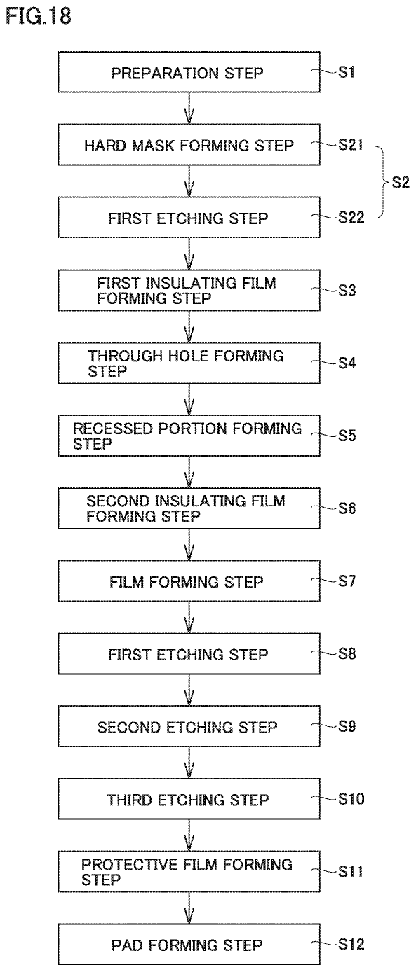

FIG. 18 is a diagram of manufacturing steps of thermal print head 200. As shown in FIG. 18, the method of manufacturing thermal print head 200 includes preparation step S1, protruding portion forming step S2, first insulating film forming step S3, through hole forming step S4, recessed portion forming step S5, second insulating film forming step S6, film forming step S7, first etching step S8, second etching step S9, third etching step S10, protective film forming step S11, and pad forming step S12. In this respect, the method of manufacturing thermal print head 200 is the same as the method of manufacturing thermal print head 100.

In the method of manufacturing thermal print head 200, protruding portion forming step S2 includes hard mask forming step S21 and first etching step S22, but does not include second etching step S23. According to the method of manufacturing thermal print head 200, in second insulating film forming step S6, a paste containing glass is applied onto the top surface of protruding portion 11 with insulating film 20 interposed therebetween, and the applied paste is fired, so that insulating film 30 containing glass as a constituent material is formed. In these respects, the method of manufacturing thermal print head 200 is the same as the method of manufacturing thermal print head 100.

### Modifications

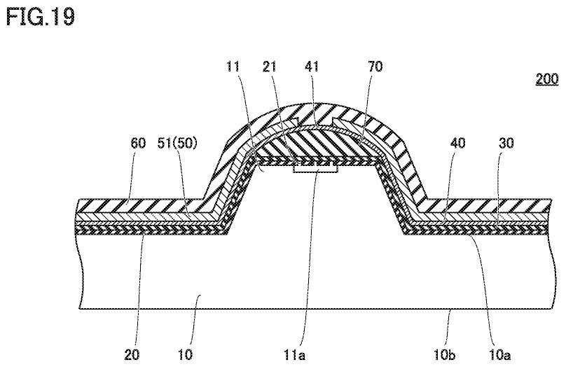

FIG. 19 is a cross-sectional view of thermal print head 200 according to a modification. As shown in FIG. 19, thermal print head 200 may have insulating film 30 similar to that of thermal print head 100 (i.e., insulating film 30 that is a plasma CVD film). In this case, thermal print head 200 further has a glaze layer 70. A constituent material of glaze layer 70 is glass. Glaze layer 70 is disposed on the top surface of protruding portion 11 with insulating films 20 and 30 interposed therebetween. Also, in this case, in a portion where wiring layer 50 overlaps with the top surface of protruding portion 11, wiring layer 50 is disposed on glaze layer 70 with resistor layer 40 interposed therebetween, and in the portion other than the above, wiring layer 50 is disposed on insulating film 30 with resistor layer 40 interposed therebetween. In this case, when glaze layer 70 is formed, a paste used for forming glaze layer 70 is prevented from falling into recessed portion 11a through the through hole 21.

### Effects of Thermal Print Head 200

Effects of thermal print head 200 will be described below.

Also in thermal print head 200, recessed portion 11a is formed in the surface (the top surface) of protruding portion 11. Thus, similarly to thermal print head 100, heat transfer from heater portion 41 to protruding portion 11 can be suppressed when the pressing force from the platen roller is relatively small, and also, heat transfer from heater portion 41 to protruding portion 11 can be promoted by increasing the pressing force from the platen roller, so that high-speed printing can be performed.

### Third Embodiment

A thermal print system according to the third embodiment will be described below. The thermal print system according to the third embodiment is referred to as a thermal print system 300.

### Configuration of Thermal Print System 300

The configuration of thermal print system 300 will be described below.

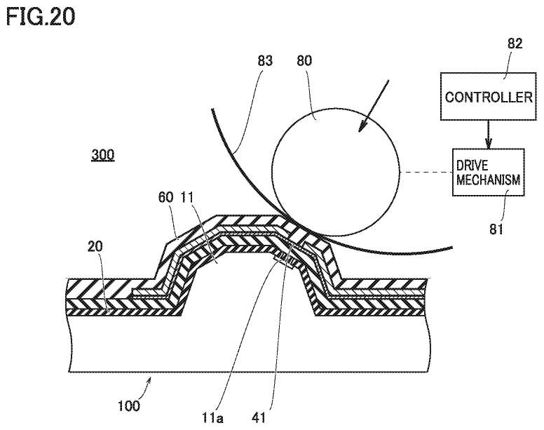

FIG. 20 is a schematic diagram of thermal print system 300. As shown in FIG. 20, thermal print system 300 has a thermal print head 100, a platen roller 80, a drive mechanism 81, and a controller 82. Platen roller 80 is driven by drive mechanism 81 and brought into contact with protective film 60 located above heater portion 41 with paper 83 interposed between platen roller 80 and protective film 60. Controller 82 outputs a control signal to drive mechanism 81 to control the operation of drive mechanism 81.

More specifically, controller 82 is capable of switching the state of pressing of platen roller 80 against thermal print head 100 between a first state and a second state. A pressing force of platen roller 80 against thermal print head 100 is larger in the second state than in the first state.

Thus, in the first state, the amount of deflection of insulating film 20 located below heater portion 41 is small, and thus, insulating film 20 located below heater portion 41 does not come into contact with the bottom surface of recessed portion 11a. In the second state, however, the amount of deflection of insulating film 20 located below heater portion 41 is large, and thus, insulating film 20 located below heater portion 41 comes into contact with the bottom surface of recessed portion 11a. In this way, thermal print system 300 can be operated while switching the operation mode between an operation mode with reduced power consumption and an operation mode that allows for high-speed printing.

In the above-described example, thermal print system 300 is configured with thermal print head 100, but thermal print system 300 may be configured with thermal print head 200 instead of thermal print head 100.

### Additional Aspects

The above-described embodiments include the following configurations.

### Additional Aspect 1

A thermal print head comprising:
a substrate;
a first insulating film; and
a second insulating film, wherein
the substrate has a first main surface and a second main surface opposite to the first main surface,
a protruding portion protruding toward a side opposite to the second main surface is formed at the first main surface,
a recessed portion is formed in a surface of the protruding portion,
the first insulating film is disposed on the first main surface to cover the protruding portion,
the second insulating film is disposed on the surface with the first insulating film interposed therebetween, and
a through hole is formed in a portion of the first insulating film, the portion facing a bottom surface of the recessed portion with a space interposed therebetween.

### Additional Aspect 2

The thermal print head according to Additional Aspect 1, wherein
the first insulating film has a first layer and a second layer,
the first layer is disposed on the first main surface to cover the protruding portion, and
the second layer is disposed on the first layer.

### Additional Aspect 3

The thermal print head according to Additional Aspect 2, wherein
a constituent material of the first layer is silicon oxide, and
a constituent material of the second layer is silicon nitride.

### Additional Aspect 4

The thermal print head according to any one of Additional Aspects 1 to 3, wherein the second insulating film is a plasma CVD film.

### Additional Aspect 5

The thermal print head according to Additional Aspect 1, wherein
the surface is a top surface of the protruding portion,
a constituent material of the second insulating film is glass, and
the second insulating film is disposed on the top surface with the first insulating film interposed therebetween.

### Additional Aspect 6

The thermal print head according to Additional Aspect 1, further comprising a glaze layer, wherein
the surface is a top surface of the protruding portion,
the second insulating film is disposed on the top surface with the first insulating film interposed therebetween,
the second insulating film is a plasma CVD film,
a constituent material of the glaze layer is glass, and
the glaze layer is disposed on the top surface with the first insulating film and the second insulating film interposed therebetween.

### Additional Aspect 7

The thermal print head according to any one of Additional Aspects 1 to 6, wherein an opening diameter of the through hole is equal to or less than a thickness of the second insulating film.

### Additional Aspect 8

The thermal print head according to Additional Aspect 7, wherein the opening diameter is equal to or less than 2 μm.

### Additional Aspect 9

The thermal print head according to any one of Additional Aspects 1 to 8, further comprising:
a resistor layer; and
a wiring layer, wherein
the wiring layer is disposed on the second insulating film with the resistor layer interposed therebetween,
the protruding portion extends in a first direction in a plan view,
the wiring layer has a plurality of wiring portions,
the plurality of wiring portions are arranged at intervals in the first direction,
each of the plurality of wiring portions extends in a second direction orthogonal to the first direction in a plan view so as to overlap with the protruding portion,
the resistor layer has a heater portion positioned to overlap with the recessed portion, and
each of the plurality of wiring portions is partially removed on the heater portion.

### Additional Aspect 10

A thermal print system comprising:
the thermal print head according to Additional Aspect 9;
a platen roller; and
a controller, wherein
the platen roller is pressed against the thermal print head with paper for printing interposed therebetween above the heater portion, and
the controller is capable of changing a state of pressing of the platen roller against the thermal print head between a first state and a second state,
   in the first state, the first insulating film is spaced apart from a bottom surface of the recessed portion and
   in the second state, the first insulating film is in contact with the bottom surface of the recessed portion.

### Additional Aspect 11

A method of manufacturing a thermal print head, the method comprising:
preparing a substrate having a first main surface and a second main surface opposite to the first main surface;
forming, on the first main surface, a protruding portion protruding toward a side opposite to the second main surface;
forming a first insulating film to cover a surface of the protruding portion;
forming a through hole in a portion of the first insulating film located on the surface;
forming a recessed portion in the surface by etching through the through hole; and
forming a second insulating film on the first main surface with the first insulating film interposed therebetween, wherein
the etching is isotropic dry etching.

### Additional Aspect 12

The thermal print system according to Additional Aspect 10, wherein
the second state is an operation mode in which a printing speed is faster than that in the first state, and
the first state is an operation mode in which power consumption is lower than that in the second state.

### Additional Aspect 13

The thermal print head according to any one of Additional Aspects 1 to 9, further comprising a heater portion disposed on the portion of the first insulating film, the portion facing the bottom surface of the recessed portion with a space interposed therebetween, wherein
heat dissipation performance of the heater portion changes according to a deflection of the portion of the first insulating film that faces the bottom surface of the recessed portion with a space interposed therebetween.

Although the embodiments of the present disclosure have been described as above, the above-described embodiments can also be variously modified. Further, the scope of the present invention is not limited to the above-described embodiments. The scope of the present invention is defined by the terms of the claims, and is intended to include any modifications within the scope and meaning equivalent to the terms of the claims.

### REFERENCE SIGNS LIST

100, 200 thermal print head, 300 thermal print system, 10 substrate, 10a main surface, 10b main surface, 11 protruding portion, 11a recessed portion, 20 insulating film, 20a first layer, 20b second layer, 21 through hole, 30 insulating film, 40 resistor layer, 41 heater portion, 50 wiring layer, 51 wiring portion, 51a, 51b wiring portion, 52 connection portion, 60 protective film, 70 glaze layer, 80 platen roller, 81 drive mechanism, 82 controller, 83 paper, DR1 first direction, DR2 second direction, HM hard mask, S1 preparation step, S2 protruding portion forming step, S21 hard mask forming step, S22 first etching step, S23 second etching step, S3 first insulating film forming step, S4 through hole forming step, S5 recessed portion forming step, S6 second insulating film forming step, S7 film forming step, S8 first etching step, S9 second etching step, S10 third etching step, S11 protective film forming step, S12 pad forming step.

1. A thermal print head comprising:
a substrate;
a first insulating film; and
a second insulating film, wherein
the substrate has a first main surface and a second main surface opposite to the first main surface,
a protruding portion protruding toward a side opposite to the second main surface is formed at the first main surface,
a recessed portion is formed in a surface of the protruding portion,
the first insulating film is disposed on the first main surface to cover the protruding portion,
the second insulating film is disposed on the surface with the first insulating film interposed therebetween, and
a through hole is formed in a portion of the first insulating film, the portion facing a bottom surface of the recessed portion with a space interposed therebetween.

2. The thermal print head according to claim 1, wherein
the first insulating film has a first layer and a second layer,
the first layer is disposed on the first main surface to cover the protruding portion, and
the second layer is disposed on the first layer.

3. The thermal print head according to claim 2, wherein
a constituent material of the first layer is silicon oxide, and
a constituent material of the second layer is silicon nitride.

4. The thermal print head according to claim 1, wherein the second insulating film is a plasma CVD film.

5. The thermal print head according to claim 1, wherein
the surface is a top surface of the protruding portion,
a constituent material of the second insulating film is glass, and
the second insulating film is disposed on the top surface with the first insulating film interposed therebetween.

6. The thermal print head according to claim 1, further comprising a glaze layer, wherein
the surface is a top surface of the protruding portion,
the second insulating film is disposed on the top surface with the first insulating film interposed therebetween,
the second insulating film is a plasma CVD film,
a constituent material of the glaze layer is glass, and
the glaze layer is disposed on the top surface with the first insulating film and the second insulating film interposed therebetween.

7. The thermal print head according to claim 1, wherein an opening diameter of the through hole is equal to or less than a thickness of the second insulating film.

8. The thermal print head according to claim 7, wherein the opening diameter is equal to or less than 2 μm.

9. The thermal print head according to claim 1, further comprising:
a resistor layer; and
a wiring layer, wherein
the wiring layer is disposed on the second insulating film with the resistor layer interposed therebetween,
the protruding portion extends in a first direction in a plan view,
the wiring layer has a plurality of wiring portions,
the plurality of wiring portions are arranged at intervals in the first direction,
each of the plurality of wiring portions extends in a second direction orthogonal to the first direction in a plan view so as to overlap with the protruding portion,
the resistor layer has a heater portion positioned to overlap with the recessed portion, and
each of the plurality of wiring portions is partially removed on the heater portion.

10. A thermal print system comprising:
the thermal print head according to claim 9;
a platen roller; and
a controller, wherein
the platen roller is pressed against the thermal print head with paper for printing interposed therebetween above the heater portion, and
the controller is capable of changing a state of pressing of the platen roller against the thermal print head between a first state and a second state,
in the first state, the first insulating film is spaced apart from a bottom surface of the recessed portion and
in the second state, the first insulating film is in contact with the bottom surface of the recessed portion.

11. A method of manufacturing a thermal print head, the method comprising:
preparing a substrate having a first main surface and a second main surface opposite to the first main surface;
forming, on the first main surface, a protruding portion protruding toward a side opposite to the second main surface;
forming a first insulating film to cover a surface of the protruding portion;
forming a through hole in a portion of the first insulating film located on the surface;
forming a recessed portion in the surface by etching through the through hole; and
forming a second insulating film on the first main surface with the first insulating film interposed therebetween, wherein
the etching is isotropic dry etching.
